(19) United States
(12) Patent Application Publication
(10) Pub. No.: US 2025/0042055 A1
(43) Pub. Date: Feb. 6, 2025

(54) ROTARY DIE CUTTER WITH CLEANING DEVICE

(71) Applicant: Kolbus GmbH & Co. KG, Rahden (DE)

(72) Inventors: Waldemar Eirich, Espelkamp (DE); Christian Schmale, Rahden (DE)

(21) Appl. No.: 18/716,395

(22) PCT Filed: Nov. 15, 2022
(86) PCT No.: PCT/EP2022/081963

§ 371 Date: Jun. 4, 2024

(30) Foreign Application Priority Data
Dec. 10, 2021 (DE) 10 2021 132 682.6

(51) Int. Cl. B26D 7/08; B08B 1/12

(52) U.S. Cl. CPC B26D 7/088; B08B 1/12

(57) ABSTRACT

A rotary die cutter comprises a cleaning device acting upon the counter die cylinder with a driven roller brush, wherein an adjustment device with a controllable drive is assigned to the roller brush and changes the axial distance of the roller brush to the counter die cylinder.

### BACKGROUND

The present invention pertains to a rotary die cutter with a cleaning device according to the preamble of claim 1.

In rotary die cutters, die cylinders cut the sheet-like material to be cut against a rotating counter die cylinder with protruding knives arranged on their cylinder surface and optionally with scoring tools. In order to reduce wear of the cutting tools, the counter die cylinder is equipped with an exchangeable covering of plastic. This counter die covering is designed in the form of a wearing part that is damaged by the cutting process.

In order to allow the prolonged use of a counter die covering with good cutting quality and to reduce production downtimes, JPH07256791A proposes a grinding device that is arranged in the rotary die cutter. This grinding device is suitable for grinding down the counter die covering within the rotary die cutter and to thereby produce a functional surface. Thereto, a grinding roller is provided approximately underneath the counter die cylinder. This grinding roller is arranged parallel to the counter die cylinder and extends over the entire width thereof.

A roller brush is provided in order to clean the cylinder surface. This roller brush likewise is arranged parallel to and approximately underneath the counter die cylinder. Dirt accumulations detached from the counter die covering are removed by suction.

In order to maintain a suitable axial distance of the brush to the counter die cylinder, it is known to equip the roller brush with rings that are designed in the form of exchangeable parts and roll on the counter die cylinder. An exchange of these rings is required if the axial distance should be changed, e.g. in order to adjust the contact pressure of the bristles. This is always associated with a machine standstill and a corresponding installation effort. Furthermore, the brush is unable to clean the regions of the counter die cylinder on which the rings roll. This also leads to dirt accumulations on adjacent regions. In addition, grinding deposits can impair the running surface of the rings, which in turn leads to an unsteady operation or even undesirable changes of the axial distance between the roller brush and the counter die cylinder.

### SUMMARY

The present invention therefore is based on the objective of developing an apparatus that is improved in comparison with the prior art and eliminates at least one of the described disadvantages of the prior art.

According to the invention, this objective is attained in a generic rotary die cutter with the characteristics of the characterizing portion of claim 1.

Thereto, the rotary die cutter has a cutting device that is arranged in a machine frame and consists of a die cylinder and a counter die cylinder interacting with the die cylinder. A cleaning device is assigned to the counter die cylinder and arranged in the same machine frame. The cleaning device comprises a roller brush. The roller brush is suitable for removing particles, particularly dust and cutting residues, from the cylinder surface of the counter die cylinder interacting with the die cylinder. Thereto, the roller brush essentially is oriented parallel to the counter die cylinder. The distance between the rotational axis of the roller brush and the rotational axis of the counter die cylinder is variable.

An adjustment device is provided in order to vary the axial distance between the roller brush and the counter die cylinder. This adjustment device acts upon the roller brush. It has a controllable drive.

The roller brush preferably is received in the machine frame so as to be displaceable relative to the counter die cylinder by means of linear guides. The linear guide makes it possible to achieve an easily mappable linear transfer function between the controllable drive and the variation of the axial distance between the roller brush and the counter die cylinder in a particularly simple manner. It is particularly advantageous to arrange the linear guides parallel to the distance between the rotational axes of the roller brush and the counter die cylinder.

In an advantageous embodiment, the controllable drive of the adjustment device comprises one or more pneumatic lifting cylinders. In this way, a robust and inexpensive construction can be realized.

The compressed air line supplying the pneumatic lifting cylinder preferably comprises a controllable pressure reducer. In this way, the force acting upon the roller brush for its positioning can be specified in a particularly simple and easily reproducible manner for the operating personnel.

It is advantageous to limit the distance between the rotational axes of the roller brush and the counter die cylinder to a predefined minimum size. In this way, inadvertent twisting or even damages resulting from an excessively high contact pressure of the roller brush on the counter die cylinder can be prevented. This can be achieved in a particularly simple manner with one or more supporting rollers of the roller brush, which roll on a running surface of the counter die cylinder extending concentric to the rotational axis of the counter die cylinder.

In a preferred embodiment, the arm connecting the supporting roller to the roller brush is designed such that its length is at least slightly variable. A spring element holds the arm at a predefined length against the force exerted by the adjustment drive. Due to a definite displacement-force function of the spring element, a desired axial distance of the roller brush to the counter die cylinder can thereby be maintained in a force-controlled manner. It is possible to realize adjustments in which the bristles of the roller brush are elastically deformed due to the contact with the counter die cylinder, as well as adjustments in which the roller brush is not in contact with the counter die cylinder, but rather maintains an adjustable distance thereto.

It is advantageous to arrange the adjustment drive, the arm of variable length and the supporting roller in such a way that the force exerted upon the supporting roller by the adjustment drive acts in the radial direction to the supporting roller.

The variability of the length of the arm is advantageously realized by means of a second linear guide that is integrated into the arm.

### BRIEF DESCRIPTION OF THE DRAWINGS

An exemplary embodiment of the invention is described below with reference to the figures, to which we refer with respect to all details that are not described in greater detail in the description. In these figures:

FIG. 1 shows a perspective view of a counter die cylinder with cleaning device;

FIG. 2 shows an adjustment device of the cleaning device; and

FIG. 3 shows a force-displacement diagram of the adjustment device.

### DETAILED DESCRIPTION

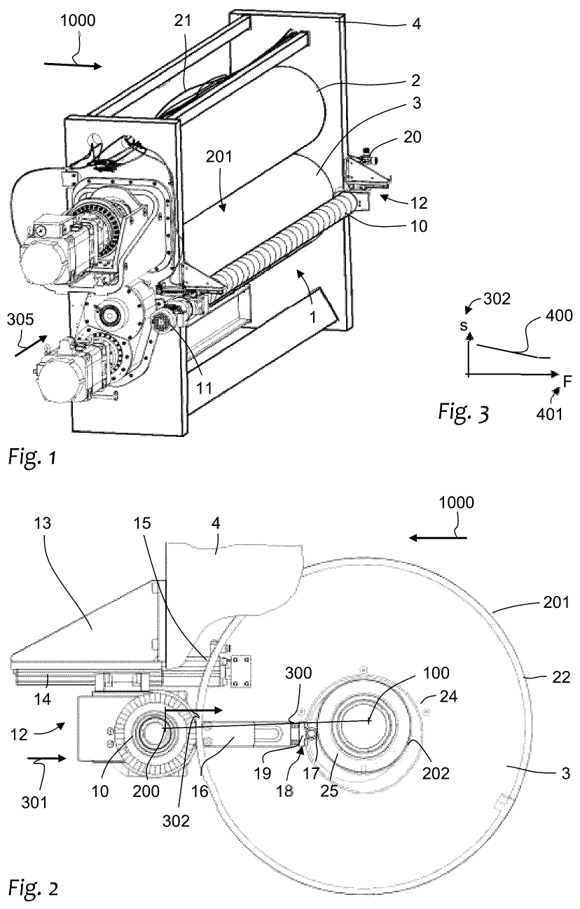

The inventive cutting device of a rotary die cutter illustrated in FIG. 1 has a driven die cylinder 2 and a counter die cylinder 3 that interacts with the die cylinder 2. The die cylinder 2 and the counter die cylinder 3 are mounted in a common machine frame 4. They are arranged parallel to one another. The conveying direction 1000 of the material to be cut extends orthogonally to the plane that is jointly defined by the rotational axis of the die cylinder 2 and the rotational axis 100 of the counter die cylinder 3.

The die cylinder 2 and the counter die cylinder 3 are arranged relative to one another in such a way that the knives of the die cylinder 2, which are not illustrated in the figures, are tangent to the surface 201 of the counter die cylinder 3 during their rotation. In order to adjust the required axial distance, the counter die cylinder 3 is received in the machine frame 4 by means of shaft shoulders 24 that are arranged eccentrically to the counter die surface 201.

The knives of the die cylinder 2 may slightly penetrate into the surface 201 of the counter die cylinder 3 in order to improve the cutting quality. The surface 201 of the counter die cylinder 3 is made of a softer material than the knives so as to prevent damages to the knives. An exchangeable covering 22 of the counter die cylinder 3 is provided in the embodiment illustrated in FIG. 2. This covering forms the entire surface 201 of the counter die cylinder 3, which comes in contact with the material to be cut and the knives of the die cylinder 2.

Impressions of the knives may be formed in the counter die covering 22 depending on the material chosen for the counter die covering 22, the quality of the knives and the adjustment of the counter die cylinder 3 relative to the die cylinder 2. These impressions are formed due to plastic deformation and/or material removal. The quality of the cut may be impaired if a knife encounters such a deformation. In order to counteract this problem, the die cylinder 2 and the counter die cylinder 3 can be displaced relative to one another in the axial direction 305. A not-shown adjustment device of conventional design, which acts upon the counter die cylinder 3, is provided for this purpose. In addition, a likewise not-shown grinding device of conventional design is provided in the apparatus and clears away the damaged surface 201 of the counter die cylinder 3 as needed.

Grinding of the counter die covering 201 slightly reduces the diameter of the counter die cylinder 3. The axial distance between the die cylinder 2 and the counter die cylinder 3 is adapted accordingly. A separately controllable drive is provided for the counter die cylinder 3 in order to maintain a desired speed ratio between the counter die surface 201 and the knives of the die cylinder 2. The drive can be controlled, for example, electronically and is connected to a not-shown machine control.

Cutting residues and dusts are created during the regular operation and during grinding of the counter die covering 22 and deposited on the counter die surface 201. They can impair the cutting quality, particularly if they are compacted by the forces occurring during the cutting process. They may also soil the material to be cut.

Consequently, a cleaning device 1 is provided and accommodated in the machine frame 4. A brush of the cleaning device 1 removes dust and other particles from the counter die surface 201. The brush is realized in the form of a driven roller brush 10. It is arranged parallel to the counter die cylinder 3. It is advantageous, but not necessary, that the roller brush 10 extends over the entire usable width of the counter die cylinder 3.

The cleaning device 1 comprises a separate drive 11 for the roller brush 10. The drive 11 is controllable. The drive 11 preferably can be controlled electronically and is connected to a not-shown electronic control of conventional design. The operation of the roller brush 10, particularly the motion profile of its rotational position, therefore can be controlled by the operating personnel via a human-machine interface or in an automated manner, e.g. based on operating states of the rotary die cutter.

An adjustment device 12 is provided in order to prevent unnecessary friction and wear of the counter die covering 22 and the roller brush 10 when the cleaning device 1 is not in operation. The adjustment device 12 of the cleaning device 1 acts upon the roller brush 10 in such a way that it varies the distance 300 between the rotational axis 200 of the roller brush 10 and the rotational axis 100 of the counter die cylinder 3. When the cleaning device 1 is not in operation, the roller brush 10 is spaced apart from and does not contact the counter die surface 201.

Thereto, the roller brush 10 is movably arranged in the machine frame 4. A linear guide 14 is provided to both sides of the roller brush 10, wherein the roller brush 10 is received in the machine frame 4 by means of said linear guides. In this case, the respective guide rail is rigidly arranged in the frame by means of a bracket 13. The roller brush 10 is mounted in the respective guide carriages. The variation of the distance 302 between the rotational axis 200 of the roller brush 10 and the rotational axis 100 of the counter die cylinder 3 is realized by means of an actuating drive of the cleaning device 1. Thereto, a pneumatic lifting cylinder 15 is respectively assigned to both guide rails. The lifting cylinders 15 are actuated by means of a controllable valve arranged upstream thereof. The valve is connected to the electronic control of the apparatus.

Supporting rollers 17 are arranged on the guide carriages of the linear guides 14 by means of an arm 16. The supporting rollers 17 are arranged in such a way that they can roll on running surfaces 202 of the counter die cylinder 3. The running surfaces 202 are respectively formed by a shaft shoulder 25 that extends concentrically to the counter die surface 201. The support of the roller brush 10 against the counter die cylinder 3 limits an approach of the roller brush 10 to the counter die cylinder 3. Due to this support against the counter die cylinder 3, the thusly defined minimum approach is also maintained when the counter die cylinder 3 is adjusted. For a definite operating state of the cleaning device 1, the lifting cylinders 15 are wired in such a way that the roller brush 10 is permanently supported against the counter die cylinder 3 by means of the arm 16 and the supporting roller 17 when the cleaning device 1 is actuated.

The arms 16 are respectively designed such that their length is variable by means of second linear guides 18. Pressure springs 19 hold the arms in the extended position. The approach 302 of the roller brush 10 to the counter die cylinder 3 as illustrated in FIG. 3 therefore is a function 400 of the spring characteristic and the force 401 exerted upon the supporting rollers 17 by the lifting cylinders 15. Consequently, the distance 300 between the rotational axis 100 of the counter die cylinder 3 and the rotational axis 200 of the roller brush 10 can be controlled or regulated with the pressure applied to the lifting cylinders 15. The air pressure is adjusted by a controllable pressure reducer 20 that is integrated into the supply line 21 of the lifting cylinders 15.

The bilateral linear guides 14 of the adjustment device 12 are arranged parallel to one another. In order to keep the control of the distance 302 simple, they are oriented parallel to the distance between the rotational axis 100 of the counter die cylinder 3 and the rotational axis 200 of the roller brush 10. The adjusting direction 301 of the roller brush 10 therefore extends radially to the counter die cylinder 3. A slight deviation from this results from the eccentric mounting of the counter die cylinder 3 in the machine frame 4 depending on the rotational position of the cylinder mounting.

The adjusting direction 301 indicated in FIG. 2 extends parallel to the conveying direction 1000 of the material to be cut. A different orientation may result depending on the arrangement of the roller brush 10 relative to the counter die cylinder 3.

### LIST OF REFERENCE SYMBOLS

1 Cleaning device
2 Die cylinder
3 Counter die cylinder
4 Machine frame
10 Roller brush
11 First drive, brush
12 Adjustment device
13 Bracket
14 First linear guide
15 Second drive, adjustment device
16 Arm
17 Supporting roller
18 Second linear guide, supporting roller
19 Pressure spring
20 Pressure reducer, controllable
21 Compressed air line
22 Counter die covering
24 Shaft shoulder, eccentric
25 Shaft shoulder, concentric
100 First rotational axis, counter die cylinder
200 Second rotational axis, brush
201 Counter die surface
202 Running surface
300 Distance of cylinder axis to brush axis
301 Adjustment device
302 Approach of brush axis to supporting roller
305 Axial adjusting direction
400 Force-displacement function
401 Radial force, supporting roller
1000 Conveying direction

1. A rotary die cutter with a machine frame (4), comprising:
a cutting device that is arranged in the machine frame (4) and comprises a rotatable die cylinder (2) and a counter die cylinder (3) interacting with the die cylinder (2), wherein
a cutting tool is arranged on the die cylinder (2) and defines an enveloping cylindrical surface of the die cylinder (2),
the counter die cylinder (3) is arranged parallel to the die cylinder (2) and rotatable about a first axis (100) and
a cylindrical surface (201) of the counter die cylinder (3) rolls on the enveloping cylindrical surface of the cutting tool, and
a cleaning device (1) that is arranged in the machine frame (4) and comprises a roller brush (10) rotatable about a second axis (200), wherein
the roller brush (10) configured to remove particles from the enveloping cylindrical surface (201) of the counter die cylinder (3),
the second axis (200) is arranged collinearly to the roller brush (10) and to the first axis (100) of the counter die cylinder (3) at a variable distance (300) and
the cleaning device (1) has a first controllable drive (11) that is operatively connected to the roller brush (10),
comprising an adjustment device (12) of the cleaning device (1), which is functionally connected to the roller brush (10), wherein the adjustment device (12) has a second controllable drive.

2. The apparatus of claim 1, comprising a first linear guide (14) of the adjustment device (12), wherein the roller brush (10) of the cleaning device (1) is received in the machine frame (4) and is displaceable relative to the counter die cylinder (3) in an adjusting direction (301) by means of the first linear guide (14).

3. The apparatus of claim 2, wherein the first linear guide (14) is oriented parallel to the distance (300) between the second axis (200) of the roller brush (10) and the first axis (100) of the counter die cylinder (3).

4. The apparatus of claim 1, wherein the second controllable drive of the adjustment device (12) has an pneumatic lifting cylinder (15).

5. The apparatus according to claim 4, comprising a controllable pressure reducer (20), wherein the controllable pressure reducer (20) is arranged in a compressed air line (21) of the pneumatic lifting cylinder (15) to predefine a force exerted by the pneumatic lifting cylinder (15).

6. The apparatus of claim 1, wherein the adjustment device (12) has a supporting roller (17) connected to the roller brush (10) by an arm (16), wherein the supporting roller (17) rolls on a cylindrical surface (202) of the counter die cylinder (3), which essentially extends concentrically to the first rotational axis (100) of the counter die cylinder (3), and the supporting roller (17) limits the variable distance (300) between the second rotational axis (200) of the roller brush (10) and the first rotational axis (100) of the counter die cylinder (3) to a predefined minimum size.

7. The apparatus of claim 6, wherein the arm (16) has an element (19) with such a resilience that the supporting roller (17) can approach the second rotational axis (200) of the roller brush (10), wherein the degree of the approach (302) in an adjusting direction (301) can be described by a definite function (400) of a radial force (401) exerted upon the supporting roller (17).

8. The apparatus of claim 7, wherein the supporting roller (17) is connected to the second controllable drive of the adjustment device (12) by the arm (16) in such a way that the controllable drive exerts the radial force (401) upon the supporting roller (17).

9. The apparatus of claim 6, comprising a second linear guide (18) of the arm (16), wherein the second linear guide (18) of the arm (16) is oriented parallel to the first linear guide (14) of the adjustment device (12) and the second linear guide (18) allows variation of a distance of the supporting roller (17) from the second rotational axis (200) of the roller brush (10).
